(19) United States
(12) Patent Application Publication
(10) Pub. No.: US 2026/0085677 A1
(43) Pub. Date: Mar. 26, 2026

(54) SYSTEMS AND METHODS FOR CAPTURING EMISSIONS WITH AN INTERNAL COMBUSTION ENGINE

(71) Applicant: Caterpillar Inc., Peoria, IL (US)

(72) Inventors: Rodney Allen Lawrence, Frankfort, IN (US); Joshua Amiel Lehe, West Lafayette, IN (US); Lucas K. Smith, Lafayette, IN (US); Andrew D. Palmer, Lafayette, IN (US); William M. Gaeta, West Lafayette, IN (US); Kenneth C. Hall, Lafayette, IN (US); Zachary Michael May, Lafayette, IN (US)

(73) Assignee: Caterpillar Inc., Peoria, IL (US)

(21) Appl. No.: 18/897,203

(22) Filed: Sep. 26, 2024

(51) Int. Cl. F04B 49/06; E21B 43/34; F02M 25/06; F04B 37/18; F04B 39/12

(52) U.S. Cl. CPC F04B 49/065; E21B 43/34; F02M 25/06; F04B 37/18; F04B 39/128

(57) ABSTRACT

Apparatuses, systems and methods are shown and described including a system to reduce emissions that includes a reciprocating gas compressor having a plurality of compression spaces and a plurality of throw spaces and an internal combustion engine. The internal combustion engine can have a closed crankcase ventilation system. The plurality of throw spaces are in fluid communication with the closed crankcase ventilation system.

### TECHNICAL FIELD

The present disclosure relates to emissions capture. More particularly, the present disclosure relates to systems and methods that capture fugitive emissions from a reciprocating gas compressor and route the emissions to an internal combustion engine.

### BACKGROUND

The oil & Gas industry has been under increasing regulation to curb emissions both at the international and national levels. Thus, the Oil & Gas industry has been reducing emissions and utilizing cleaner processing techniques. In the United States, the Inflation Reduction Act (signed into law Aug. 16, 2022) includes new taxes for methane emissions. As such, there is an ever-increasing focus by Oil & Gas producers to reduce emissions through the development of new technologies and processes.

Regulated emissions include methane, a component of natural gas. Natural gas primarily comprises methane, along with heavier and more complex hydrocarbons such as ethane, propane, butane, pentane, etc. Burning methane in the atmosphere produces carbon dioxide, water vapor and a small amount of nitrogen oxides. Methane along with carbon dioxide and nitrogen oxides are considered greenhouse gases.

Oil & gas industry must gather and then deliver raw gas to processing plants. This delivery system consists of gathering and transmission lines with miles of pipe which operate at varying pressures. Compressors are used to move gas through the pipeline system by boosting the pressure of the gas to meet pipeline pressure requirements. The most common compressor package is a natural gas fired engine coupled to a reciprocating compressor. Such reciprocating compressor can be configured to operate anywhere from one to four stages of compression. These compressors range from 1000 to 6000 horsepower. It is common to build compression stations having several compressor packages operating in parallel, to centralize and optimize production.

Reciprocating compressors are known to leak small amounts of greenhouse gases during operation. This generally occurs because packing seals on a cylinder's rod become worn and are subject to very high pressures. Such wear and conditions allows natural gas that would otherwise be compressed and forced onward in the pipeline to leak from a plurality of compression spaces back into a plurality of throw spaces. Typical practice is to vent these throw spaces to atmosphere to prevent excessive pressure buildup within the compressor.

Internal combustion engines combust a mixture of air and fuel in cylinders and thereby produce drive torque and power. A portion of the combustion gases (termed “blow-by”) may escape the combustion chamber past the piston and enter undesirable areas of the engine such as the crankcase. Blow-by can contain un-combusted fuel, oil and explosive gases. In rare cases, un-combusted fuel and/or explosive gases can build within the engine such as within the crankcase. The un-combusted fuel and/or explosive gases can result in an explosion if not properly mitigated such as by a relief valve. Crankcase ventilation systems are known in internal combustion engines to vent, capture or dilute blow-by gases of the crankcase. Such ventilation systems can include oil separation devices as part of such systems. For example, U.S. Pat. Nos. 8,992,667B2 and 7,320,316B2 and United States Patent Application Publication No. US2009/0293852A1 disclose examples of crankcase ventilation systems. However, these patents and patent applications do not capture emissions from a reciprocating gas compressor as recognized in the present application.

### SUMMARY

In an example according to this disclosure, a system to reduce emissions optionally including: a reciprocating gas compressor having a plurality of compression spaces and a plurality of throw spaces; and an internal combustion engine. The internal combustion engine having a closed crankcase ventilation system. The plurality of throw spaces are in fluid communication with the closed crankcase ventilation system.

In some examples according to this disclosure, a method of capturing emissions optionally including: communicating the emissions from a plurality of throw spaces of a reciprocating gas compressor; and combining the emissions with a blow-by gas at a closed crankcase ventilation system of an internal combustion engine.

In some examples according to this disclosure, the a system to reduce emissions optionally including: a reciprocating gas compressor and an internal combustion engine. The reciprocating compressor can have a plurality of compression spaces and a plurality of throw spaces. The reciprocating gas compressor can have a plurality of pistons movable within the plurality of compression spaces. The internal combustion engine can be configured to drive the plurality of pistons of the reciprocating gas compressor. A closed crankcase ventilation system in fluid communication with a crankcase of the internal combustion engine and in selective fluid communication with the plurality of throw spaces.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a partial cross-sectional view of a reciprocating gas compressor in accordance with an example of the present application.

FIG. 2 is a schematic illustration of a system including the reciprocating gas compressor of FIG. 1 and an internal combustion engine with the reciprocating gas compressor in fluid communication with and receiving a drive torque from the internal combustion engine according to one example of the present application.

FIG. 3 is a schematic view of a system that includes a reciprocating gas compressor and an internal combustion engine that has a closed crankcase ventilation system with the closed crankcase ventilation system in fluid communication with a plurality of throws of the reciprocating gas compressor according to a first example of the present application.

FIG. 4 is a schematic view of a system that includes the reciprocating gas compressor and the internal combustion engine that has the closed crankcase ventilation system in fluid communication with the plurality of throws of the reciprocating gas compressor according to a second example of the present application.

FIG. 5 is a schematic view of a system that includes the reciprocating gas compressor and the internal combustion engine that has the closed crankcase ventilation system in fluid communication with the plurality of throws of the reciprocating gas compressor according to a third example of the present application.

FIG. 6 is a schematic view of a system that includes the reciprocating gas compressor and the internal combustion engine that has the closed crankcase ventilation system in fluid communication with the plurality of throws of the reciprocating gas compressor according to a fourth example of the present application.

FIG. 7 is a schematic view of a system that includes the reciprocating gas compressor and the internal combustion engine that has the closed crankcase ventilation system in fluid communication with the plurality of throws of the reciprocating gas compressor according to a fifth example of the present application.

### DETAILED DESCRIPTION

Examples according to this disclosure are directed to capture of emissions from one or more reciprocating gas compressors using a closed crankcase ventilation system of an internal combustion engine. Examples of the present disclosure are now described with reference to the accompanying drawings. The following description is merely exemplary in nature and is not intended to limit the present disclosure, application, or use. Examples described set forth specific components, devices, and methods, to provide an understanding of embodiments of the present disclosure. It will be apparent to those skilled in the art that specific details need not be employed and that examples may be embodied in many different forms. Thus, the examples provided should not be construed to limit the scope of the claims.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Further, relative terms, such as, for example, “about,” “substantially,” “generally,” and “approximately” are used to indicate a possible variation of ±10% in a stated value.

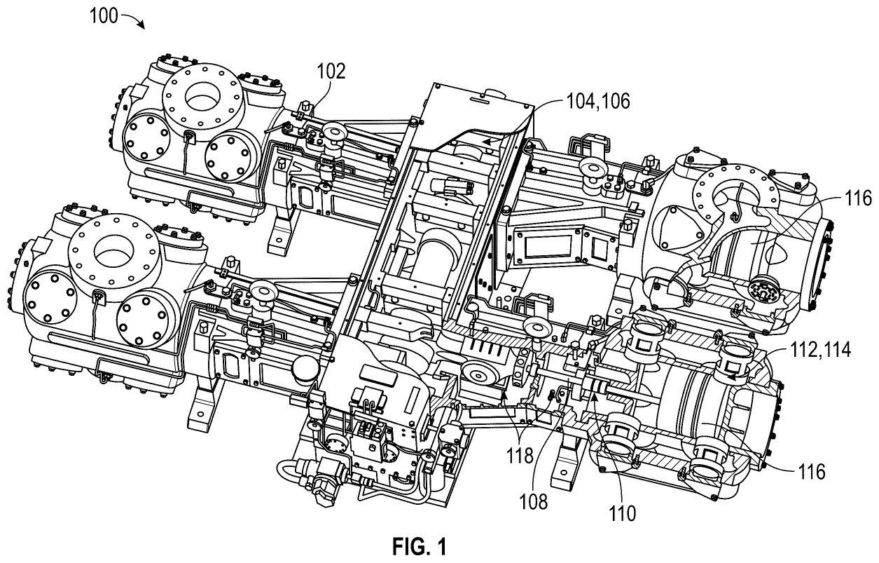

FIG. 1 depicts a partial cross-sectional view of a reciprocating gas compressor 100. The reciprocating gas compressor 100 can include a housing 102 (partially removed in FIG. 1), a manifold 104, a crankshaft 106, a plurality of rods 108 (only one rod illustrated in FIG. 1), a plurality of packing seals 110, a plurality of cylinders 112 (only one shown in FIG. 1) defining a plurality of compression spaces 114 (only one shown in FIG. 1), and a plurality of pistons 116 (only two shown in FIG. 1).

As shown in FIG. 1, the housing 102 can define a plurality of throw spaces 118 (only one shown in FIG. 1). Each of the plurality of throw spaces 118 can surround the plurality of rods 108 and can be positioned adjacent the plurality of packing seals 110. The plurality of throw spaces 118 can be separated from the plurality of compression spaces 114. The plurality of throw spaces 118 can be in fluid communication with the manifold 104. However, in other embodiments the plurality of throw spaces 118 may not communicate together to the manifold 104 but can be separate from one another.

As shown in FIG. 1, the housing 102 can enclose the various components including the manifold 104, the crankshaft 106, the plurality of rods 108, the plurality of packing seals 110, the plurality of cylinders 112, the plurality of compression spaces 114, the plurality of pistons 116 and the plurality of throw spaces 118. The housing 102 can include one or more ports or relief valves as further discussed herein.

The reciprocating gas compressor 100 has a generally symmetric shape with the plurality of rods 108 connected to and extending outward from the centrally located crankshaft 106 in a staggered axial manner. The crankshaft 106 can be located in the manifold 104, which can be centrally located relative to the plurality of rods 108 and the plurality of pistons 116. The plurality of pistons 116 are moveably received in the plurality of cylinders 112. Thus, the plurality of pistons 116 are movable within the plurality of compression spaces 114. During operation, the plurality of pistons 116 are translated within the plurality of cylinders 112 by rotation of the crankshaft 106 and linear translation of the plurality of rods 108. This movement of the plurality of pistons 116 alters the size of the plurality of compression spaces 114 causing a desired compression of natural gas that is communicated into the plurality of compression spaces 114. After compression by action of the plurality of pistons 116, the compressed natural gas can be communicated from the plurality of compression spaces 114 onward from the reciprocating gas compressor 100 to pipeline infrastructure as known in the art.

The plurality of rods 108 are connected to and extend from the crankshaft 106. Each of the plurality of rods 108 is connected to a respective one of the plurality of pistons 116. The plurality of packing seals 110 can be located on each of the plurality of rods 108 (or on the housing 102 so as to interact with the plurality of rods 108) at a passage of the plurality of rods 108 through a portion of the housing 102 that separates the plurality of compression spaces 114 from the plurality of throw spaces 118. The plurality of packing seals 110 are configured to seal the plurality of throw spaces 118 from the plurality of compression spaces 114. However, as discussed previously, the plurality of packing seals 110 can allow a small amount of emissions to escape when new, and with wear can allow for an increasing amount of emissions to migrate from the plurality of compression spaces 114 to the plurality of throw spaces 118 and onward to the manifold 104.

As used herein the term “emissions” is used to identify natural gas and constituents thereof including methane, ethane, propane, butane, pentane, etc. The term “emissions” additionally can include in some cases airborne particulate such as oil or the like. For clarity, the term “emissions” is used herein separately from “blow-by gas” which is combustion gases that escape a combustion chamber of an internal combustion engine past the piston. Blow-by gas can contain un-combusted fuel (in some cases natural gas), oil and explosive gases. It should therefore be understood that although the terms “emissions” and “blow-by gas” are used separately in the present application to track respective constituents that have leaked past the plurality of packing seals 110 from the reciprocating compressor and products of combustion that have leaked to undesired areas of the internal combustion engine, these terms can designate the same or similar gases such as natural gas and other constituents such as oil that are shared in common.

The reciprocating gas compressor 100 can be of a typical construction having one to four throws as known in the art. Examples of reciprocating gas compressor 100 include but are not limited to: Ariel JGC4 reciprocating compressor, Ariel JGA-4 reciprocating compressor, Ariel JGT-4 reciprocating compressor, Arial KBE reciprocating compressor and Ariel JGD reciprocating compressor. Other reciprocating gas compressors from other OEM manufacturers are also contemplated for use with the systems and methods of the present application. In FIG. 1, the housing 102 is modified to remove one or more breathers or other ports to atmosphere that would otherwise be located to communicate with the manifold 104 or the plurality of throw spaces 118. These ports or breathers to atmosphere are replaced and the housing 102 or another portion of the reciprocating gas compressor 100 can configured to couple with one or more passages such as line, tube, pipe, hose, etc. that are connected to an internal combustion engine as further discussed herein. The terms “passage”, “passages”, “passageway”, “passageways”, “fluid communication”, “fluidly communicate” or similar terms as used herein should be interpreted broadly. These terms can be features defined by one or more components (e.g., a line, a hose, tube, pipe, manifold, cavity etc.) or direct connection as known in the art. In some cases, the reciprocating gas compressor 100 can be integrated into an internal combustion engine so as to form an assembly such that a dedicated external passage extending between the compressor to the internal combustion engine is not required.

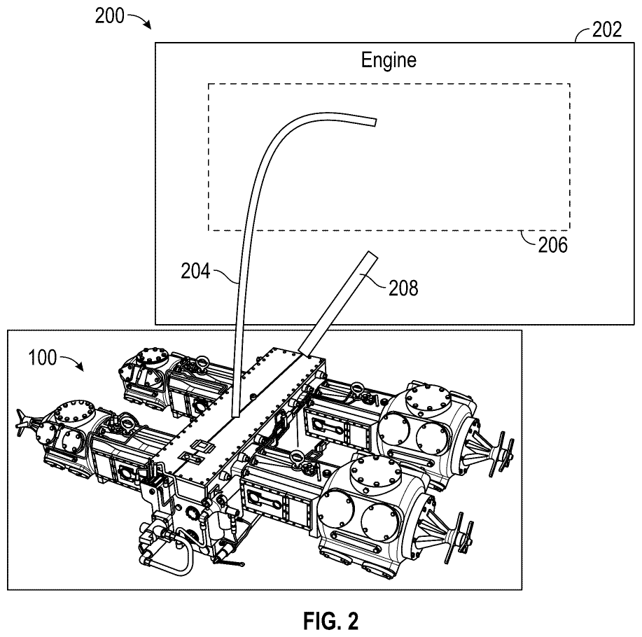

FIG. 2 shows a system 200 that includes the reciprocating gas compressor 100 being powered by and in fluid communication with an internal combustion engine 202. The internal combustion engine 202 can include utilize gaseous fuel including natural gas or can utilize dynamic gas blending. The internal combustion engine 202 can be a spark ignited reciprocating engine, for example. It is understood that the present disclosure can apply to any number of piston-cylinder arrangements and a variety of engine configurations including, but not limited to, V-engines, inline engines, and horizontally opposed engines, as well as overhead cam and cam-in-block configurations.

As illustrated in FIG. 2, a passage 204 connects the manifold 104 (FIG. 1) of the reciprocating gas compressor 100 with a crankcase 206 of the internal combustion engine 202. In this manner, the plurality of throw spaces 118 (FIG. 1) are in fluid communication with the crankcase 206 of the internal combustion engine 202. The passage 204 can be coupled to a port or connection feature of the reciprocating gas compressor 100. The passage 204 can be a plurality of passages. The passage 204 can be heated and insulated to prevent emulsion and freezing of the emissions from the reciprocating gas compressor 100 during transportation to the internal combustion engine 202.

As shown in FIG. 2, the internal combustion engine 202 is configured to drive the plurality of pistons 116 (FIG. 1) of the reciprocating gas compressor 100 via a drive shaft 208 coupled to the crankshaft 106 (FIG. 1) of the reciprocating gas compressor 100.

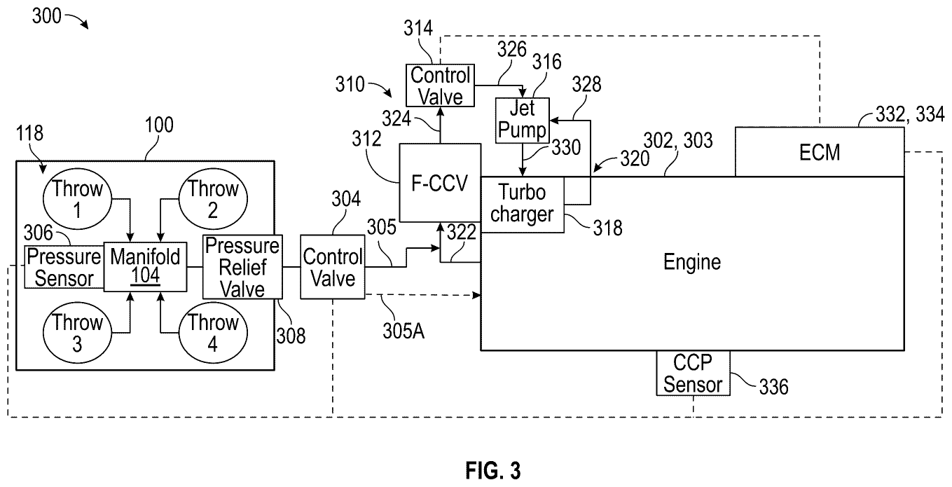

FIG. 3 is a schematic view of a system 300 that includes the reciprocating gas compressor 100, an internal combustion engine 302 (e.g., the internal combustion engine 202 or another internal combustion engine) and a first control valve 304. Although FIGS. 3-6 show embodiments in which emissions from the reciprocating gas compressor are passed to a single turbo engine air system, the concepts described and illustrated are also applicable to multi-turbo air systems where emissions from the reciprocating compressor 100 can be split/divided and passed to two or more of the multi-turbo air systems.

FIG. 3 illustrates schematically various components of the reciprocating gas compressor 100 including the manifold 104 and the plurality of throw spaces 118. As previously described and illustrated in FIG. 1, the plurality of throw spaces 118 are in fluid communication with the manifold 104. The reciprocating gas compressor 100 can additionally include other components including a first pressure sensor 306 and a pressure relief valve 308. The first pressure sensor 306 can be configured to sense a first pressure within the manifold 104 of the reciprocating gas compressor 100. The pressure relief valve 308 can be in fluid communication with the manifold 104 and can be configured to open to release the emissions to atmosphere should the manifold 104 become over-pressured in an undesired manner.

The first control valve 304 can be a pressure control valve (PCV) such as a vacuum control valve, for example. The first control valve 304 can be in fluid communication with the manifold 104 via a first passage 305. The control valve 304 can be an electronically controlled valve such as a butterfly and/or solenoid valve, a mechanical valve such as spring-loaded plunger or diaphragm valve, etc. The first control valve 304 can be configured to be electronically controlled to be opened, closed or modulated to be incrementally opened according to some examples. The first control valve 304 can be configured to regulate a flow of the emissions between the plurality of throw spaces 118 and a closed crankcase ventilation system 310 of the internal combustion engine 302.

The internal combustion engine 302 can include the closed crankcase ventilation system 310. As shown in FIG. 3, the first control valve 304 can be configured to regulate a flow of the emissions along the first passage 305 between the plurality of throw spaces 118 (via the manifold 104) and the closed crankcase ventilation system 310. As discussed previously with regard to FIG. 2, the first passage 305 can be heated and/or insulated. Thus, the reciprocating gas compressor 100 can be in fluid communication with the closed crankcase ventilation system 310 as selectively regulated by the first control valve 304.

The closed crankcase ventilation system 310 can be configured to receive blow-by gas from the internal combustion engine 302. The closed crankcase ventilation system 310 can include at least one filter module 312 (e.g., a single device or an array of a plurality of oil separation devices). Examples of suitable filter module(s) 312 include oil separation devices as described in United States Patent Application Publication No. 2024/0218816A1 and U.S. Pat. Nos. 11,867,099B1 and 11,946,397, the disclosures of each of which is incorporated herein by reference in its entirety.

The closed crankcase ventilation system 310 can further include additional auxiliary components to the internal combustion engine 302 such as a second control valve 314, a jet pump 316 and a turbocharger 318. In the example of FIG. 3, the closed crankcase ventilation system 310 can be part of the original manufacture of the internal combustion engine 302 or can be a retrofitted system that is added to the internal combustion engine 302 during maintenance, upgrade or the like. The second control valve 314 can have a construction similar or identical to that of the first control valve 304.

The closed crankcase ventilation system 310 can use the filter module(s) 312 to separate oil from the blow-by gas and emissions to reduce volatile content in the blow-by gas and emissions. Components of the closed crankcase ventilation system 310 such as the turbocharger 318 can be part of a charge air system 320 of the internal combustion engine 302. As such, the charge air system 320 is configured to increase the density of gas (including emissions and blow-by gas) entering the engine's combustion chamber using a compressor driven by a turbine.

According to other examples, the closed crankcase ventilation system 310 can be part of or can be used in combination with a purge system, which can be in fluid communication with a crankcase 303 of the internal combustion engine 302 such as via an inlet passageway. The closed crankcase ventilation system 310 can be configured to supply gas to the crankcase 303 and through the engine block or through other components (not shown) to a cylinder head of the internal combustion engine 302. The gas the internal combustion engine 302 supplies can act to ventilate the crankcase 303 and other components of the internal combustion engine 302 such as the cylinder head, the rocker box, etc. This ventilation, in addition to operation of the filter module(s) 312 to separate oil from the blow-by gas, can dilute un-combusted fuel, explosive gases and/or volatiles below a lower explosive limit so as to prevent or reduce the likelihood of an explosion within the internal combustion engine 302.

The closed crankcase ventilation system 310 can include a series of flow connected passages (some specifically illustrated by and numbered in FIG. 1) that are in fluid communication with the various components of the closed crankcase ventilation system 310. Some components of the internal combustion engine 302 such as the engine block, the crankcase 303, the cylinder head, the rocker box, the valve cover and/or the breather can be in fluid communication internally within the internal combustion engine 302. The passages can also connect the filter module(s) 312, the second control valve 314, the jet pump 316 and the turbocharger 318 together as further described herein.

Dirty blow-by gas containing oil and volatiles of the closed crankcase ventilation system 310 can pass along a passage 322 from a breather or other device of the internal combustion engine 302 and can pass to the filter module(s) 312 for filtering of oil to reduce volatile content of the blow-by gas. The passage 322 can additionally be connected to the first passage 305 at a location upstream of the filter module(s) 312 (according to the flow direction of the blow-by gas and the emissions). According to another embodiment, the first passage 305A (indicated with dashed line) can communicate directly with the crankcase 303. Thus, the filter module(s) 312 can filter a combined flow of both the blow-by gas and the emissions. The combined flow of gas (blow-by gas and emissions), after filtering of the oil, can pass from the filter module(s) 312 along passage 324. The passage 324 connects to the second control valve 314 located between the filter module(s) 312 and the jet pump 316. The second control valve 314 can be in fluid communication with and can regulate the blow-by gas from the engine and the emissions from the reciprocating compressor. The second control valve 314 can be configured to regulate the combined flow of the blow-by gas and the emissions to control a vacuum of the jet pump 316. The blow-by gas and emissions (the combined gas flow) can pass from the second control valve 314 along a passage 326 to the suction of the jet pump 316.

In tandem with the blow-by gas, closed crankcase ventilation system 310 can utilize boost air from the turbocharger 318 (or another component such as a compressor). This boost air moves along passage 328 to the jet pump 316. The jet pump 316 can use the boost air as motive air for drawing the blow-by gas through the filter module(s) 312 and the emissions from the manifold 104 along the first passage 305. Thus, according to the example of FIG. 3, the blow-by gas and emissions (the combined gas flow) after leaving the second control valve 314 can be routed to a suction port of the jet pump 316. The boost air from the turbocharger 318 can be routed to an inlet port of the jet pump 316. The blow-by gas, emissions and the boost air can be further combined in the jet pump 316. In particular, the jet pump 316 can be configured to pass the blow-by gas, emissions and the boost air through a venturi of the jet pump 316. Some or all of this further combined airflow can pass along passage 330 to be returned to the internal combustion engine 302, for example at an inlet to a compressor of the turbocharger 318. Thus, the jet pump 316 and the turbocharger 318 are configured to create a vacuum that draws both the emissions and the blow-by gas through the closed crankcase ventilation system 310. This combined air flow can pass to the compressor of the turbocharger (e.g., also part of the charge air system 320), which can be configured to receive and compress the air. The compressed air can then pass from the turbocharger 318 to combustion chambers of the internal combustion engine 302 as fuel. Optionally, other components such as an aftercooler can be utilized as part of the charge air system 320. However, these components are not specifically shown herein.

Although the present closed crankcase ventilation system 310 illustrates use of the jet pump 316, the jet pump 316 can be eliminated according to other embodiments and is not a necessary component of the closed crankcase ventilation system 310. Similarly, although the turbocharger 318 is described, it is recognized other components such as a compressor could be utilized rather than the turbocharger 318.

As shown in FIG. 3, the system 300 can include an electronic controller 332. The electronic controller 332 can be an engine control module (ECM) 334, another controller or sub-controller, for example. The electronic controller 332 can electronically communicate with the first control valve 304, the first pressure sensor 306, the second control valve 314 and a second pressure sensor 336 (e.g., a pressure sensor positioned within the crankcase 303) as indicated with dashed lines in FIG. 3. The electronic controller 332 can be configured to control the first control valve 304 and/or the second control valve 314 based upon a first pressure data from the first pressure sensor 306 indicative of a first pressure within the manifold 104 and/or can control the first control valve 304 and/or the second control valve 314 based upon a second pressure data from the second pressure sensor 336 indicative of a second pressure within the crankcase 303. Thus, the electronic controller 332 (e.g., the ECM 334) can control at least one of the first control valve 304 and the second control valve 314 based upon the first pressure and/or the second pressure. Thus, a single control valve, such as the first control valve 304, can regulate the pressure of the crankcase 303 as well as the pressure of one or more of the plurality of throw spaces 118 of the reciprocating gas compressor 100. According to the example of FIG. 3, the electronic controller 332 (e.g., the ECM 334) can control the first control valve 304 and/or the second control valve 314 to regulate the first pressure to be substantially equal to the second pressure. According to yet further examples, the internal pressure of the reciprocating compressor can differ from the internal pressure within the internal combustion engine. Thus, the engine control module separately regulates the first control valve based upon a first comparison of the first pressure with a desired internal pressure (e.g., a positive pressure, an atmospheric pressure, etc.) for the reciprocating gas compressor and regulates the second control valve based upon a second comparison of the second pressure with a desired internal pressure internal combustion engine (e.g., a small positive pressure, an atmospheric pressure, etc.). The ECM 334 can monitor flow of the emissions (and in some cases the blow-by gas) via flow sensors and/or the first pressure sensor 306 and/or the second pressure sensor 336 and can control operation (e.g., perform an E-stop) of the internal combustion engine 302 and/or the reciprocating gas compressor 100 if too much flow is passing to the internal combustion engine 302.

The electronic controller 332 can include, for example, software, hardware, and combinations of hardware and software configured to execute several functions related to, among others, monitoring and controlling pressures. The electronic controller 332 can be an analog, digital, or combination analog and digital controller including a number of components. As examples, the electronic controller 332 can include integrated circuit boards or ICB(s), printed circuit boards PCB(s), processor(s), data storage devices, switches, relays, or any other components. Examples of processors can include any one or more of a microprocessor, a controller, a digital signal processor (DSP), an application specific integrated circuit (ASIC), a field-programmable gate array (FPGA), or equivalent discrete or integrated logic circuitry. Commercially available microprocessors can be configured to perform the functions of the electronic controller 332. Various known circuits may be associated with electronic controller 332, including power supply circuitry, signal-conditioning circuitry, actuator driver circuitry (circuitry driving valves), and communication circuitry. In some examples, the electronic controller 332 may be positioned on the engine, while in other examples the electronic controller 332 may be positioned at an off-board location (remote location) relative to the engine.

The electronic controller 332 can include a memory such as memory circuitry. The memory may include storage media to store and/or retrieve data or other information such as, for example, first pressure data from the first pressure sensor 306, second pressure data from the second pressure sensor 336, any additional data, etc. Storage devices, in some examples can be a computer-readable storage medium. The data storage devices can be used to store program instructions for execution by processor(s) of the electronic controller 332, for example. The storage devices, for example, are used by software, applications, algorithms, as examples, running on and/or executed by the electronic controller 332. The storage devices can include short-term and/or long-term memory and can be volatile and/or non-volatile. Examples of non-volatile storage elements include magnetic hard discs, optical discs, floppy discs, flash memories, or forms of electrically programmable memories (EPROM) or electrically erasable and programmable (EEPROM) memories. Examples of volatile memories include random access memories (RAM), dynamic random-access memories (DRAM), static random-access memories (SRAM), and other forms of volatile memories known in the art.

The system 300 can include one or more remote servers, processors, or other such computing devices such as the electronic controller 332. In some examples, the electronic controller 332 can be connected to one another and/or otherwise in communication with one another and with various components such as the first control valve 304, the first pressure sensor 306, the second control valve 314 and the second pressure sensor 336 and/or other components of the system 300 via a network. The network may be a local area network (“LAN”), a larger network such as a wide area network (“WAN”), or a collection of networks, such as the Internet. Protocols for network communication, such as TCP/IP, may be used to implement the network. Although examples are described herein as using a network such as the Internet, other distribution techniques may be implemented that transmit information.

The system 300 can, in the context of software, include steps that represent computer-executable instructions stored in memory. When such instructions are executed by, for example, the electronic controller 332, such instructions cause the electronic controller 332, various components of the system 300, to perform operations. The computer-executable instructions may include routines, programs, objects, components, data structures, and the like that perform particular functions or implement particular abstract data types. The order in which the operations are described is not intended to be construed as a limitation, and any number of the described steps can be combined in any order and/or in parallel to implement the processes and components discussed in regards to the system 300.

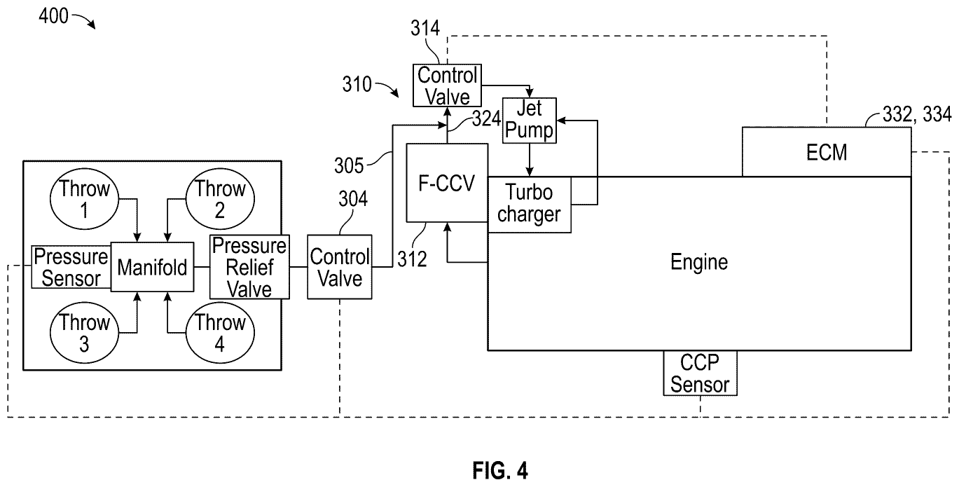

FIG. 4 shows a schematic of another system 400 constructed in a manner similar to that of the system 300 described previously. The system 400 differs from the system 300 in that the system 400 has the emissions combine with the blow-by gas to become part of the closed crankcase ventilation system 310 after filtering of the blow-by gas using the filter module(s) 312. Thus, the example of FIG. 4 passes the blow-by gas from the filter module(s) 312 along passage 324, which is connected with the first passage 305 upstream (according to the flow direction of the blow-by gas and the emissions) of the second control valve 314 and downstream of the filter module(s) 312. Additionally, according to the example of FIG. 4, the electronic controller 332 (e.g., the ECM 334) can control the first control valve 304 and/or the second control valve 314 to regulate the first pressure to be substantially equal to the second pressure.

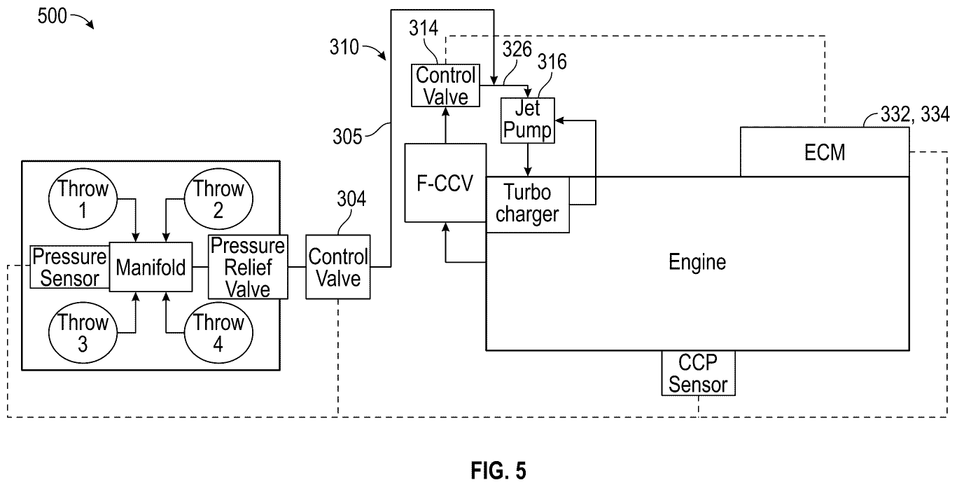

FIG. 5 shows a schematic of another system 500 constructed in a manner similar to that of the systems 300 and 400 described previously. The system 500 differs from the systems 300 and 400 in that the system 500 has the first passage 305 combine with the passage 326 downstream of (according to a flow direction of the blow-by gas) the second control valve 314. Thus, the emissions can be communicated to the closed crankcase ventilation system 310 between the second control valve 314 and the jet pump 316. Additionally, according to the example of FIG. 5, the electronic controller 332 (e.g., the ECM 334) can control the first control valve 304 and/or the second control valve 314 to regulate the first pressure to be substantially equal to the second pressure.

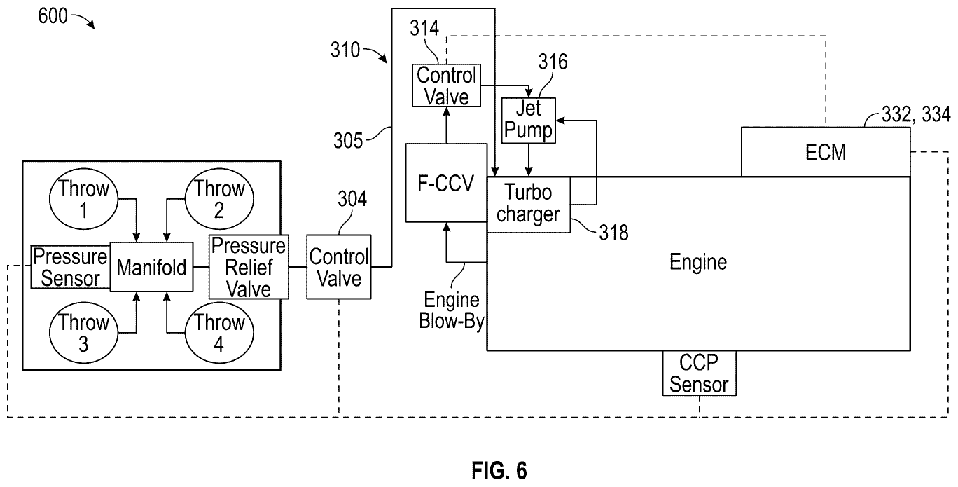

FIG. 6 shows a schematic of another system 600 constructed in a manner similar to that of the systems 300, 400 and 500 described previously. The system 600 differs from the system 300 in that the system 600 has the first passage 305 connect directly with a compressor inlet of the turbocharger 318. Thus, the emissions can be communicated to the closed crankcase ventilation system 310 downstream of the jet pump 316 and can be routed directly into the turbocharger 318. Additionally, according to the example of FIG. 6, the electronic controller 332 (e.g., the ECM 334) can control the first control valve 304 and/or the second control valve 314 to regulate the first pressure to be substantially equal to the second pressure. According to yet further examples, the internal pressure of the reciprocating compressor can differ from the internal pressure within the internal combustion engine. Thus, the engine control module separately regulates the first control valve based upon a first comparison of the first pressure with a desired internal pressure (e.g., a positive pressure, an atmospheric pressure, etc.) for the reciprocating gas compressor and regulates the second control valve based upon a second comparison of the second pressure with a desired internal pressure internal combustion engine (e.g., a small positive pressure, an atmospheric pressure, etc.).

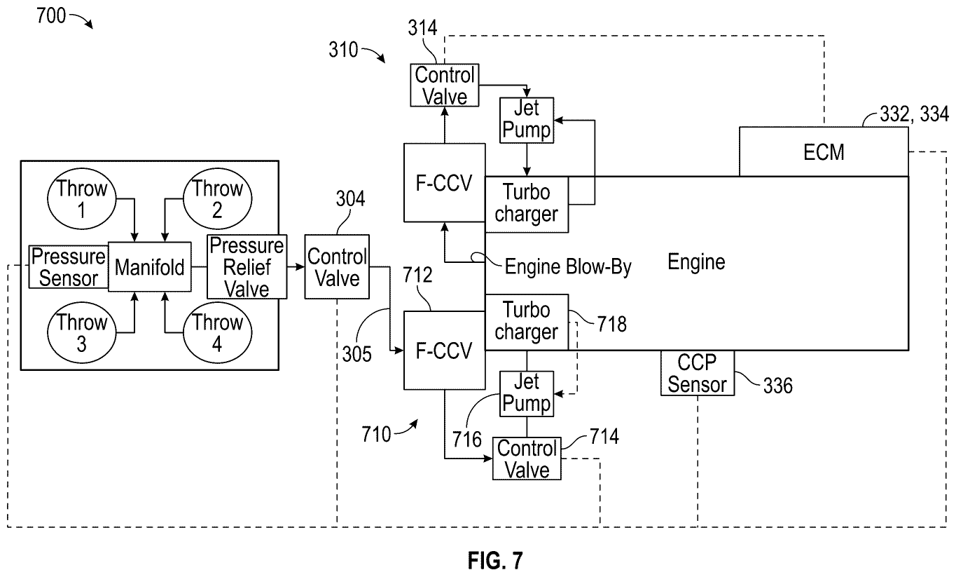

FIG. 7 shows a schematic of yet another system 700. FIG. 7 shows an embodiment in which emissions from the reciprocating gas compressor are passed to one of two or more multi-turbo engine air systems. However, the concepts described and illustrated are also applicable to a single turbo air system where emissions from the reciprocating compressor 100 are directed only to the single turbo engine air system at the filter module(s) 712. The system 700 has a construction similar to the system 300 but the system 700 utilizes a dual turbocharged internal combustion engine (an example of a multi-turbo engine air system). As such, a dedicated closed crankcase ventilation system 710 that is fully separate from the closed crankcase ventilation system 310 can be used to capture and process the emissions from the reciprocating gas compressor 100. Thus, the closed crankcase ventilation system 310 can be used only for capturing and processing of the blow-by gas from the engine while the closed crankcase ventilation system 710 can be utilized for the capturing and processing of only the emissions. FIG. 7 further illustrates that according to some embodiments the first passage 305 can be directly routed as the sole input to a filter module(s) 712. The closed crankcase ventilation system 710 can be constructed in the manner of those systems discussed previously and can include a third control valve 714, a second jet pump 716 and a second turbocharger 718. As with the prior described systems, components such as the second jet pump 716 can be optional and may not be utilized according to some examples.

The system 700 can include the electronic controller 332 such as the ECM 334. The electronic controller 332 can electronically communicate with the first control valve 304, the first pressure sensor 306, the second control valve 314, the second pressure sensor 336 and the third control valve 714, for example. The electronic controller 332 can be configured to control the first control valve 304, the second control valve 314 and/or the third control valve 714 based upon a first pressure data from the first pressure sensor 306 indicative of a first pressure within the manifold 104 and/or can control the first control valve 304, the second control valve 314 and/or the third control valve 714 based upon a second pressure data from the second pressure sensor 336 indicative of a second pressure within the crankcase. Thus, the electronic controller 332 (e.g., the ECM 334) can control at least one of the first control valve 304, the second control valve 314 and the third control valve 714 based upon the first pressure and/or the second pressure. According to the example of FIG. 7, the electronic controller 332 (e.g., the ECM 334) can control the first control valve 304, the second control valve 314 and the third control valve 714 to regulate the first pressure to be substantially equal to the second pressure. According to yet further examples, the internal pressure of the reciprocating compressor can differ from the internal pressure within the internal combustion engine. Thus, the engine control module separately regulates the first control valve based upon a first comparison of the first pressure with a desired internal pressure (e.g., a positive pressure, an atmospheric pressure, etc.) for the reciprocating gas compressor and regulates the second control valve based upon a second comparison of the second pressure with a desired internal pressure internal combustion engine (e.g., a small positive pressure, an atmospheric pressure, etc.).

### INDUSTRIAL APPLICABILITY

In operation, the internal combustion engine 202, 302 can be configured to combust fuel to generate power. This power can be transferred to the reciprocating gas compressor 100. The reciprocating gas compressor can operate to compress natural gas. While typically efficiently sealed, a small portion of the natural gas being compressed can escape one or more of the plurality of compression spaces 114 via passing through worn packing seals 110 and enter the one or more of the plurality of throw spaces 118. This natural gas, termed emissions herein, would typically be released to atmosphere using a breather or other port. Such release would incur a tax as discussed herein as a greenhouse gas.

The present disclosure contemplates use of the systems 300, 400, 500, 600 and 700 having the closed crankcase ventilation system 310 and/or 710 of the internal combustion engine 302. This closed crankcase ventilation system 310 and/or 710 is utilized to capture and process the emissions that would otherwise have been released to the atmosphere. As an example, the emissions can be combined with blow-by gas from operation of the internal combustion engine 302 and can be routed back to the charge air system 320 of the internal combustion engine 302. Alternatively, the emissions can be captured separate form the blow-by gas and routed to the internal combustion engine 302 to become part of the charge air system 320. Thus, release of the emissions to atmosphere that would otherwise occur can be avoided.

In some embodiments, oil within the emissions can be captured by the filter module(s) 312 or 712. Additional benefits can include: the dilution of the emissions with the blow-by gas and reingestion of the combined gas into the charge air system 320 as charge air; the pressure within the plurality of throw spaces 118 is actively regulated to substantially a same pressure as locations along the closed crankcase ventilation system; and this regulation can be accomplished utilizing a single control valve or tandem control of two or more control valves. The systems and methods contemplate one or more of the plurality of throw spaces 118 can be subjected either to atmospheric pressure or a relatively small positive pressure.

The present application discloses a method of capturing emissions. The method includes communicating the emissions from a plurality of throw spaces of a reciprocating gas compressor as shown in FIGS. 2-7. The method includes combining the emissions with a blow-by gas at a closed crankcase ventilation system of an internal combustion engine such as shown in FIGS. 3-6. The method includes passing the emissions and the blow-by gas to a crankcase of the internal combustion engine as shown in FIGS. 2-7. The method can optionally include regulating a flow of the emissions to the closed crankcase ventilation system and regulating a flow of the blow-by gas through the closed crankcase ventilation system. The method can include sensing a first pressure indicative of pressure of one or more of the plurality of throw spaces, sensing a second pressure within the crankcase, and equalizing the first pressure with the second pressure by the regulating the flow of the emissions to the closed crankcase ventilation system and the regulating the flow of the blow-by gas to the closed crankcase ventilation system.

According to yet further examples, the method can include sensing a first pressure indicative of a pressure of one or more of the plurality of throw spaces, sensing a second pressure within the crankcase, flowing the emissions to the closed crankcase ventilation system and flowing the blow-by gas to the closed crankcase ventilation system In some examples, the engine control module separately regulates the first control valve based upon a first comparison of the first pressure with a desired internal pressure for the reciprocating gas compressor and regulates the second control valve based upon a second comparison of the second pressure with a desired internal pressure internal combustion engine. The method can include regulating a flow of the emissions to the closed crankcase ventilation system and regulating a flow of the blow-by gas through the closed crankcase ventilation system The method can include drawing a vacuum using a turbocharger or a combination of the turbocharger and a jet pump to communicate the emissions from the plurality of throw spaces. The method can combine the emissions with the blow-by gas downstream, at or upstream of a filter module of the closed crankcase ventilation system relative to a direction of a flow of the blow-by gas. The combining the emissions with the blow-by gas at the closed crankcase ventilation system can occur upstream of or downstream of a control valve of the closed crankcase ventilation system relative to a direction of a flow of the blow-by gas. The method can include heating one or more lines that communicate the emissions between the plurality of throw spaces and the closed crankcase ventilation system. In one example, the closed crankcase ventilation system is one of at least two closed crankcase ventilation systems. In this example, the plurality of throw spaces are in fluid communication with only one of the at least two closed crankcase ventilation systems. The passing the emissions and the blow-by gas to the crankcase of the internal combustion engine can include passing the emissions and the blow-by gas to a charge air system of the internal combustion engine.

The above detailed description is intended to be illustrative, and not restrictive. The scope of the disclosure should, therefore, be determined with references to the appended claims, along with the full scope of equivalents to which such claims are entitled.

What is claimed is:

1. A system to reduce emissions comprising:
a reciprocating gas compressor having a plurality of compression spaces and a plurality of throw spaces; and
an internal combustion engine, the internal combustion engine having a closed crankcase ventilation system, wherein the plurality of throw spaces are in fluid communication with the closed crankcase ventilation system.

2. The system of claim 1, further comprising:
a pressure relief valve; and
a first control valve configured to regulate a flow of the emissions between the plurality of throw spaces and the closed crankcase ventilation system.

3. The system of claim 2, further comprising:
a second control valve configured to regulate at least one of: a flow of a blow-by gas through the closed crankcase ventilation system or a combined flow of the blow-by gas and the emissions through the closed crankcase ventilation system.

4. The system of claim 3, further comprising:
an engine control module; and
a first pressure sensor configured to sense a first pressure within a manifold of the reciprocating gas compressor, wherein the manifold is in fluid communication with at least two of the plurality of throw spaces;
a second pressure sensor configured to sense a second pressure within a crankcase of the internal combustion engine;
wherein the engine control module is in electronic communication with the first pressure sensor, the second pressure sensor, the first control valve and the second control valve, and wherein the engine control module controls at least one of the first control valve and the second control valve based upon the first pressure and the second pressure.

5. The system of claim 4, wherein the engine control module separately regulates the first control valve based upon a first comparison of the first pressure with a desired internal pressure for the reciprocating gas compressor and regulates the second control valve based upon a second comparison of the second pressure with a desired internal pressure internal combustion engine.

6. The system of claim 3, wherein the closed crankcase ventilation system includes:
a filter module;
a jet pump in fluid communication with the filter module; and
a turbocharger in fluid communication with the jet pump;
wherein the second control valve is positioned between the filter module and the jet pump;
and wherein the plurality of throw spaces are in fluid communication with the closed crankcase ventilation system upstream of or downstream of the second control valve relative to a direction of the flow of the blow-by gas.

7. The system of claim 6, wherein the plurality of throw spaces are in fluid communication with the closed crankcase ventilation system downstream of, at or upstream of the filter module.

8. The system of claim 1, wherein the closed crankcase ventilation system is one of at least two closed crankcase ventilation systems, and wherein the plurality of throw spaces are in fluid communication with only one of the at least two closed crankcase ventilation systems.

9. A method of capturing emissions comprising:
communicating the emissions from a plurality of throw spaces of a reciprocating gas compressor; and
combining the emissions with a blow-by gas at a closed crankcase ventilation system of an internal combustion engine.

10. The method of claim 9, wherein the combining the emissions and the blow-by gas includes passing the emissions and the blow-by gas to a charge air system of the internal combustion engine.

11. The method of claim 9, further comprising:
sensing a first pressure indicative of a pressure of one or more of the plurality of throw spaces;
sensing a second pressure within a crankcase;
flowing the emissions to the closed crankcase ventilation system; and
flowing the blow-by gas to the closed crankcase ventilation system.

12. The method of claim 11, further comprising:
regulating a flow of the emissions to the closed crankcase ventilation system; and
regulating a flow of the blow-by gas through the closed crankcase ventilation system.

13. The method of claim 9, further comprising drawing a vacuum using a turbocharger or a combination of the turbocharger and a jet pump to communicate the emissions from the plurality of throw spaces.

14. The method of claim 9, wherein the combining the emissions with the blow-by gas at the closed crankcase ventilation system occurs downstream of, at or upstream of a filter module of the closed crankcase ventilation system relative to a direction of a flow of the blow-by gas.

15. The method of claim 9, wherein the combining the emissions with the blow-by gas at the closed crankcase ventilation system occurs upstream of or downstream of a control valve of the closed crankcase ventilation system relative to a direction of a flow of the blow-by gas.

16. The method of claim 9, further comprising heating one or more lines that communicate the emissions between the plurality of throw spaces and the closed crankcase ventilation system.

17. The method of claim 9, wherein the closed crankcase ventilation system is one of at least two closed crankcase ventilation systems, and wherein the plurality of throw spaces are in fluid communication with only one of the at least two closed crankcase ventilation systems.

18. A system to reduce emissions comprising:
a reciprocating gas compressor having a plurality of compression spaces and a plurality of throw spaces, wherein the reciprocating gas compressor has a plurality of pistons movable within the plurality of compression spaces;
an internal combustion engine configured to drive the plurality of pistons of the reciprocating gas compressor; and
a closed crankcase ventilation system in fluid communication with a crankcase of the internal combustion engine and in selective fluid communication with the plurality of throw spaces.

19. The system of claim 18, further comprising:
a first control valve configured to regulate a flow of the emissions between the plurality of throw spaces and the closed crankcase ventilation system.
a second control valve configured to regulate at least one of: a flow of a blow-by gas through the closed crankcase ventilation system or a combined flow of the blow-by gas and the emissions through the closed crankcase ventilation system;
an engine control module;
a first pressure sensor configured to sense a first pressure within a manifold of the reciprocating gas compressor, wherein the manifold is in fluid communication with at least two of the plurality of throw spaces; and
a second pressure sensor configured to sense a second pressure within a crankcase of the internal combustion engine;
wherein the engine control module is in electronic communication with the first pressure sensor, the second pressure sensor, the first control valve and the second control valve, and wherein the engine control module controls at least one of the first control valve and the second control valve based upon the first pressure and the second pressure.

20. The system of claim 19, wherein the closed crankcase ventilation system includes:
a filter module;
a jet pump in fluid communication with the filter module; and
a turbocharger in fluid communication with the jet pump;
wherein the second control valve is positioned between the filter module and the jet pump;
wherein the jet pump and the turbocharger are configured to create a vacuum that draws both the emissions and the blow-by gas through the closed crankcase ventilation system.
